(19) United States
(12) Patent Application Publication
(10) Pub. No.: US 2008/0312955 A1
(43) Pub. Date: Dec. 18, 2008

(54) SYSTEM FOR PREVENTATIVE MEASURES TO MAINTAIN HEALTH AND WELLNESS

(75) Inventors: Brian S. Hewitt, West Des Moines, IA (US); Chris L. Haviland, West Des Moines, IA (US)

Correspondence Address: ZARLEY LAW FIRM P.L.C., CAPITAL SQUARE, 400 LOCUST, SUITE 200, DES MOINES, IA, 50309-2350, US

(73) Assignee: GROUP BENEFITS, LTD., Urbandale, IA (US)

(21) Appl. No.: 11/764,536

(22) Filed: Jun. 18, 2007

(51) Int. Cl. G06Q 50/00

(52) U.S. Cl. 705/2; 600/300

(57) ABSTRACT

A system for providing preventative measures to maintain the health and wellness of an individual includes a personal health record accessible through a website connected to an electronic network. The personal health record includes medical history of an individual, at least one health risk assessment, and educational information personalized for the individual based on the individual's medical history and health risk assessment.

### BACKGROUND OF THE INVENTION

The invention is directed toward a system for promoting the health and wellness of an individual.

The value of a healthier employee base offers many positive outcomes for an employer. For example, employees who maintain good health, experience less absenteeism and are move productive at work. They also tend to have a more positive attitude as compared to unhealthy employees.

In addition, over the long term, healthier employees can result in lower health insurance premiums for the employer and employee alike. According to the Journal of Occupational and Environmental Medicine, people who complete a Health Risk Assessment (HRA) cost an average of $262 less per year in medical costs. Simply completing an HRA and becoming aware of their health status will motivate many individual's to make positive lifestyle changes.

In addition to completing an HRA, some individuals join fitness centers, consult with trainers and/or wellness coaches, and visit medical professionals in order to maintain their health and wellness. What is lacking is a comprehensive system that links and coordinates all elements that lead to an individual's well being. Further, presently there exists no employer based system that provides incentives to motivate individual's to participate and persist in a wellness plan, making employees/individuals accountable for following through. Therefore, there exists a need in the art for comprehensive wellness system that addresses these deficiencies.

Accordingly, an objective of the present invention is to provide a system that links and coordinates a plurality of health care entities over an electronic network.

Another objective of the present invention is to provide incentives to motivate individuals to participate in a comprehensive wellness plan.

A still further objective of the present invention is to provide a system that assists an employer to identify health needs of its employees, monitor progress, provide a more productive work force, and potentially reduce health care costs.

These and other objectives will be apparent to those skilled in the art based on the following disclosure.

### SUMMARY OF THE INVENTION

A system for providing preventative measures to maintain the health and wellness of an individual includes a personal health record accessible through a website connected to an electronic network. The personal health record includes medical history of an individual, at least one health risk assessment, and educational information personalized for the individual based on the individual's medical history and health risk assessment.

Connected to the personal health record through the electronic network is a fitness center, a wellness coach, medical professionals, an employer, and a participating individual. Each of these groups has access to portions of the personal health record, and are capable of inputting information for the purpose of developing a wellness plan, encouraging an individual's participation, monitoring progress, and providing incentives and encouragement to continue with the wellness plan.

### BRIEF DESCRIPTION OF THE DRAWINGS

FIG. 1 is a schematic drawing of a working environment for a wellness system; and

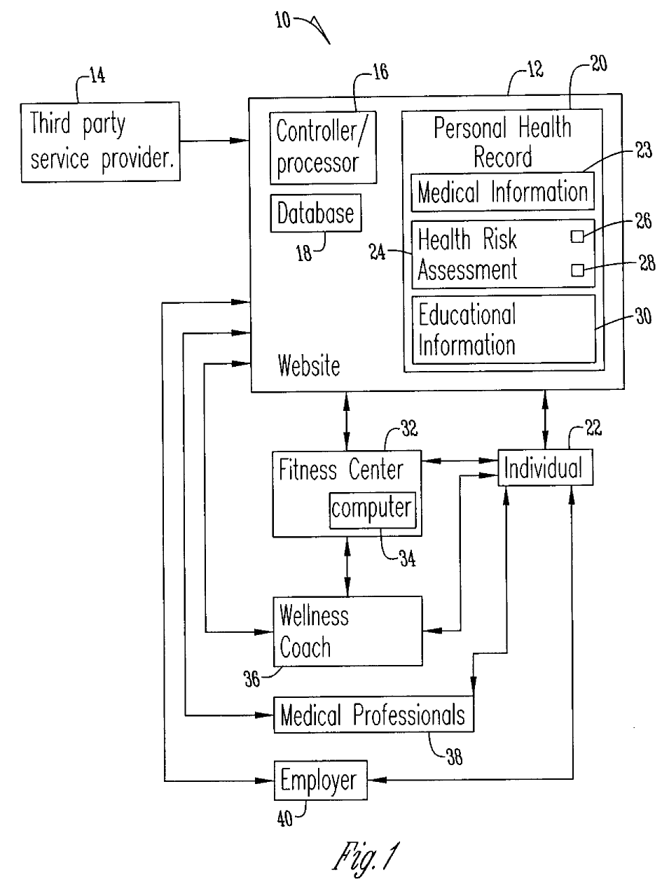

FIG. 2 is a flow diagram of a system to maintain health and wellness.

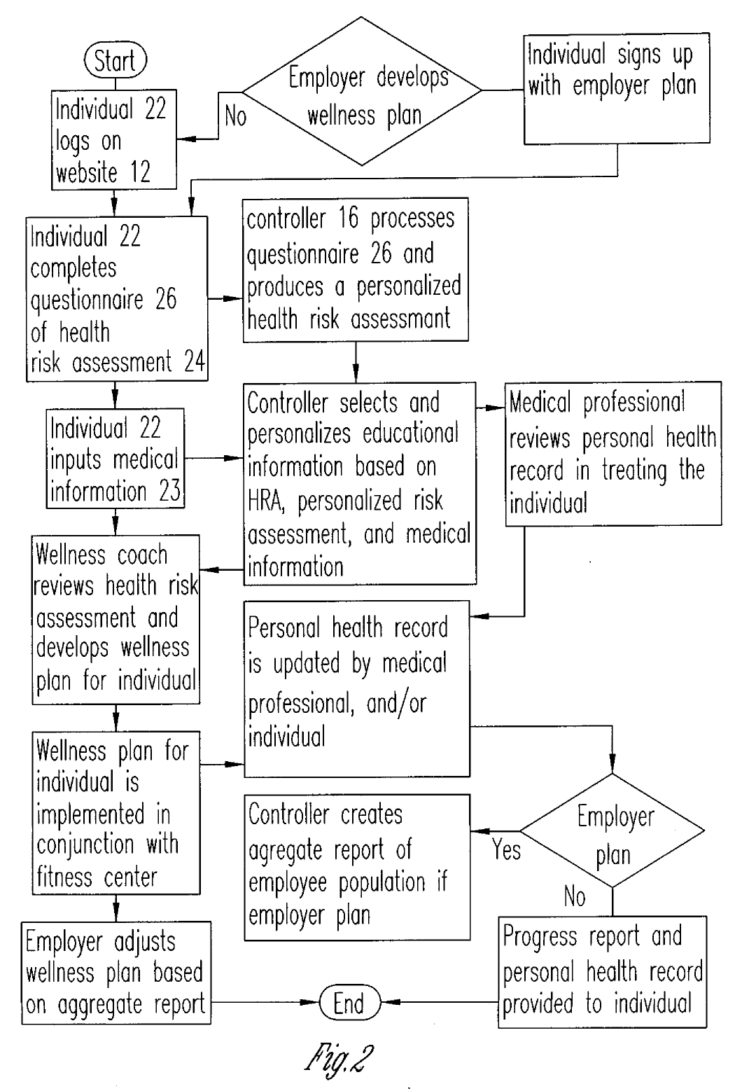

### DETAILED DESCRIPTION OF THE PREFERRED EMBODIMENT

The system 10 for a comprehensive wellness plan includes a website 12 provided by a third-party service provider 14 over a third-party network. Connected to the website 12 is a controller/processor 16 having a secured database 18. The database 18 includes a personal health record (PHR) 20 for each individual 22 who is registered and/or authorized to participate in the wellness plan system 10.

The PHR 20 includes medical information 23 such as medical history, family history, lab test results, insurance, contact information, and prescription history. In addition, the PHR provides and stores health risk assessments (HRA) 24 that are completed by the individual 22. The HRA 24 includes an on-line questionnaire 26 that has questions tailored to an individual's age, gender, and other characteristics. Preferably HRAs 24 are to be completed periodically by the individual 22 and stored within the database 18 for historical reference. The HRA 24 also includes a personalized health assessment 28 which provides information based on the individual's responses to the questionnaire 26 such as overall risk, lifestyle behaviors, health status, current medical condition, future risk of disease, and the like.

Also stored within the database is a library of educational information 30 that is personalized and provided to the individual 22 based upon their responses to the questionnaire 26 and/or the personalized health assessment 28. Educational information 30 is also provided to the individual 22 based upon medical information 23. Alternatively, the educational information 30 is maintained in a separate and remote database that is electronically linked to the controller/processor 16 and the PHR 20. The educational information 30 includes recommended exercise programs, a diet plan and recipes, factors leading to health problems, recommended lifestyle changes, recommended treatments, and referrals to health care professionals. Preferably, the health care professionals pay the service provider a fee for a referral.

The system further includes a fitness center 32 having various exercise equipment and health and fitness programs. Located at the fitness center 32 is a computer 34 that is connected to the PHR 20 via the electronic network. Either provided by, or available at, the fitness center 32 is a computer 34 that is connected to the PHR 20 via the electronic network. Either provided by, or available at, the fitness center 32 is a wellness coach 36. The wellness coach 36 assists the individual 22 in developing, adjusting, and maintaining a health program. The computer 34 provides online access for the individual 22 and/or the wellness coach 36 to the PHR 20 either to display information from the PHR 20 such as the personalized health risk assessment 28, the personalized educational information 30, and/or the medical information 23, or to input information to record biometric data (height, weight, blood pressure, etc.), workouts completed, and health progress. Based on information that is inputted by the wellness coach 36 and/or the individual 22, personalized educational information 30 is sent to the individual 22 and/or the wellness coach that provides encouragement to continue with a health program and recommendations on how to progress further.

In addition to the fitness facility 32, at least one and preferably more medical professionals 38 are electronically connected to the PHR 20. Medical professionals 38 include but are not limited to doctors, physical therapists, chiropractors, dentists, and pharmacists. Like the wellness coach 36, the medical professionals are able to access information from the PHR 20 or input information that is stored within the database 18 for the individual's PHR. Thus, when an individual 22 visits a medical professional 38 not only does the medical professional 38 have access to the individual's medical information 23, personalized health risk assessment 28, and health plan progress, but the medical professional 38 and/or the individual 22 can input new medical information such as health status, lab results, prescriptions, treatment plans and the like.

In an alternative embodiment the individual's employer 40 is connected to the service provider 14 via the electronic network. In this embodiment the employer 40 has established a wellness plan to potentially benefit, maintain, improve, or prevent health issues for a plurality of employee/individuals 22. In establishing the wellness plan the employer 40 provides access for the individual 22 to the system 10 as well as incentives not only to participate in a wellness plan, but to persist in wellness plan activities over a period of time. For example, as an incentive the employer 40 agrees to pay a portion of or all of the individual's health insurance if the individual completes at least one health risk assessment per year, eight workouts at the fitness facility per month, and/or has a physical once a year. The employer 40, as one incentive, may pay the membership fee for the fitness facility 32 and pay for or provide the wellness coach 36.

Through its connection with the service provider 14, the employer 40 is able to obtain an aggregate report 42 of the health condition of its employees. For example, the aggregate report 42 provides a profile of the health risks of the employee/individuals population. In addition, the report 42 provides information on employee compliance with the employer's incentive plan. Based on the aggregate report 42 the employer 40 is able to track the progress of its wellness/incentive plan, adjust the wellness/incentive plan to address the health risks of its employee population, and provide information to its insurance carrier on the health condition of its employee population.

The wellness coach 36, medical professionals 38, and employer 40 have limited access to the individual's PHR 20 through portals based upon the individual's authorization to each entity.

What is claimed is:

1. A system for providing preventative measures to maintain the health and wellness of an individual, comprising:
a personal health record accessible through a website connected to an electronic network;
the personal health record including at least one health risk assessment and personalized medical information;
a fitness center connected to the personal health record through the electronic network; and
a wellness coach capable of accessing portions of the personal health record through the electronic network and capable of developing a wellness plan based upon the personal health record.

2. The system of claim 1 wherein the personal health record has educational information that is provided based upon at least one of the medical information and the health risk assessment.

3. The system of claim 1 further comprising at least one medical professional capable of accessing portions of the personal health record through the electronic network.

4. The system of claim 1 wherein an individual is capable of accessing the personal health record through the electronic network.

5. The system of claim 1 wherein an employer is capable of accessing portions of the personal health record through the electronic network.

6. The system of claim 5 wherein an employer receives an aggregate report that summarizes health conditions of an employee population.

7. The system of claim 6 wherein an employer develops a wellness plan based upon the aggregate report.

8. The system of claim 1 wherein the wellness coach is capable of inputting information into the personal health record.

9. The system of claim 3 wherein the medical professional is capable of inputting information into the personal health record.

10. The system of claim 4 wherein the individual is capable of inputting information into the personal health record.

11. A system for providing preventive measures to maintain the health and wellness of an individual, comprising:
a personal health record accessible through a website connected to an electronic network;
the personal health record including at least one health risk assessment and personalized medical information;
a fitness center connected to the personal health record through the electronic network; and
a wellness coach capable of accessing portions of the personal health record through the electronic network and capable of developing a wellness plan based upon the personal health record; wherein the personal health record has educational information that is provided based upon at least one of the medical information and the health risk assessment; further comprising at least one medical professional capable of accessing portions of the personal health record through the electronic network; wherein an individual is capable of accessing the personal health record through the electronic network.

12. The system of claim 11 wherein an employer is capable of accessing portions of the personal health record through the electronic network.

13. The system of claim 12 wherein an employer receives an aggregate report that summarizes health conditions of an employee population.

14. The system of claim 13 wherein an employer develops a wellness plan based upon the aggregate report.

15. The system of claim 11 wherein the wellness coach is capable of inputting information into the personal health record.

16. The system of claim 11 wherein the medical professional is capable of inputting information into the personal health record.

17. The system of claim 11 wherein the individual is capable of inputting information into the personal health record.
